(19) United States
(12) Patent Application Publication
(10) Pub. No.: US 2013/0121693 A1
(43) Pub. Date: May 16, 2013

(54) OPTICAL TRANSMISSION SYSTEM, PUMP-LIGHT SUPPLY CONTROL METHOD, AND PUMP LIGHT SUPPLY APPARATUS

(71) Applicants: Toshiki TANAKA, Setagaya (JP); Takeshi HOSHIDA, Kawasaki (JP); Masato NISHIHARA, Kawasaki (JP); Shoichiro ODA, Fuchu (JP)

(72) Inventors: Toshiki TANAKA, Setagaya (JP); Takeshi HOSHIDA, Kawasaki (JP); Masato NISHIHARA, Kawasaki (JP); Shoichiro ODA, Fuchu (JP)

(73) Assignee: FUJITSU LIMITED, Kawasaki-shi (JP)

(21) Appl. No.: 13/613,951

(22) Filed: Sep. 13, 2012

(30) Foreign Application Priority Data
Nov. 15, 2011 (JP) 2011-250023

(51) Int. Cl. H04J 14/02

(52) U.S. Cl. 398/48; 398/82

(57) ABSTRACT

An optical transmission system for communicating between transmission devices includes a first pump light source that supplies a first pump light, a second pump light source that supplies a second pump light, an optical transmission line that propagates an optical signal between the transmission devices, and a plurality of couplers that form a plurality of zones in the transmission line, the first pump light source and the second pump light source being optically connected to different couplers of the plurality of couplers, the second pump light Raman-amplifying the first pump light in a zone in which the second pump light is input in the transmission line.

### CROSS-REFERENCE TO RELATED APPLICATION

This application is based upon and claims the benefit of priority of the prior Japanese Patent Application No. 2011-250023, filed on Nov. 15, 2011, the entire contents of which are incorporated herein by reference.

### FIELD

The embodiment discussed herein is related to an optical transmission system, pump-light supply control method, and pump light supply apparatus. Examples of the optical transmission system may include an optical transmission system that uses distributed Raman amplification, which amplifies signal light by employing an optical transmission line as an amplification medium.

### BACKGROUND

In a traditional optical transmission system, a repeating device between an optical transmitting station and an optical receiving station performs 3R regeneration of re-amplification, re-timing, and re-shaping in the state where signal light is converted into an electrical signal, then converts the electrical signal into signal light, and sends it to the next repeating device.

An optical amplifier that amplifies an optical signal directly is becoming commercially practical, and the use of an optical transmission system that uses such an optical amplifier in repeating processing is being pursued. The optical transmission system using the optical amplifier may have a significantly reduced number of components included in each device, have an improved reliability, and additionally, be produced at reduced cost.

With the wide spread of the Internet and the like, the amount of information transmitted over a network is increased, and techniques for increasing the capacity of an optical transmission system are studied actively.

One example method for achieving an increased capacity of an optical transmission system is wavelength division multiplex (WDM) optical transmission technology.

WDM optical transmission technology is technology that multiplexes a plurality of signals using a plurality of carrier waves having different wavelengths. With this technology, the amount of information transmitted per optical fiber is dramatically increased.

One example of the configuration of an optical transmission system that uses the WDM optical transmission technology is illustrated in FIG. 1.

The optical transmission system illustrated in FIG. 1 may include an optical transmitting station 1, an optical receiving station 2, an optical transmission line 3 connecting the optical transmitting station 1 and the optical receiving station 2, and optical amplifiers 4 arranged at appropriate locations in the optical transmission line 3.

The optical transmitting station 1 may include a plurality of optical transmitters 1A for outputting respective signal light components having different wavelengths, a multiplexer 1B for multiplexing the wavelengths of the signal light components, and a post-amplifier 1C for amplifying WDM light output from the multiplexer 1B to a given level and sending the WDM light to the optical transmission line 3, for example. Each of the optical transmitters 1A illustrated in FIG. 1 is configured as an electrical/optical converter (E/O) for converting data as an electrical signal into an optical signal.

The optical transmission line 3 may be made of an optical fiber that connects the optical transmitting station 1 and the optical receiving station 2, for example. At least one optical amplifier 4 is disposed in the optical transmission line 3. WDM light sent from the optical transmitting station 1 is subjected to a repeat of propagation in the optical transmission line 3 and amplification by the optical amplifiers 4 and then reaches the optical receiving station 2.

The optical receiving station 2 may include a pre-amplifier 2C for receiving the WDM light from the optical transmitting station 1 and amplifying it to a given level, a demultiplexer 2B for demulitiplexing the amplified WDM light for each wavelength, and a plurality of optical receivers 2A for performing given reception processing on the demultiplexed signal light components. Each of the optical receivers 2A illustrated in FIG. 1 is configured as an optical/electrical converter (O/E) for converting an optical signal into an electrical signal.

Each of the optical amplifiers 4 in the optical transmission system is typically an erbium doped fiber amplifier (EDFA).

The gain wavelength band of an EDFA is 1.55 μm band (also called C band), whereas the gain wavelength band of a gain shifted-EDFA (GS-EDFA) in which the gain band is shifted to a long wavelength side is 1.58 μm band (also called L band). Because each of the gain wavelength bands has a wavelength bandwidth of 30 nm or more, a signal light band of 60 nm or more may be achieved by a combined use of two signal-light wavelength bands using a multiplexer and demultiplexer for C band and that for L band.

To the demand for increasing the capacity of an optical transmission system, in addition to the pursuit of the above-described widening of the band of signal light, research and development of an optical transmitter and receiver that has a communication capacity per wavelength of approximately 40 Gb/sec or approximately 100 Gb/sec or more is conducted.

Unfortunately, however, when the transmission capacity per wavelength is increased, the optical signal to noise ratio (OSNR) is reduced and the quality of a transmission signal is further degraded.

An approach to improving the OSNR in an optical transmission system is the use of distributed Raman amplification technology. Distributed Raman amplification technology indicates amplification technology that employs an optical transmission line as an amplification medium. In contrast, lumped Raman amplification indicates amplification technology that employs an optical transmission line in an optical transmitting station, optical receiving station, or optical repeater as an amplification medium.

For distributed Raman amplification technology, because the optical level diagram within a transmission zone is further flattened, the OSNR for signal light after transmission may be improved and the nonlinear effect in the optical transmission line may be reduced.

The gain peak optical frequency in Raman amplification is smaller than the frequency of pump light by approximately 13.2 THz, and the Raman amplification gain is present in a longer wavelength region than the wavelength of pump light. For example, when the wavelength of pump light is 1.45 μm, the peak wavelength in the Raman amplification gain is 1.55 μm, which is shifted from 1.45 μm to a long wavelength side by approximately 100 nm.

Accordingly, for Raman amplification, adjustment of the wavelength and power of each pump light may flatten the amplification gain and control the wavelength band and bandwidth that are the target of Raman amplification.

As related art, International Publication Pamphlet No. WO 2002/017010 mentioned below describes a method of obtaining a substantially flat gain as a function of wavelength in the whole optical communication system by supplying pump lights having two or more wavelengths from at least two stations of a transmitting station, a receiving station, and repeater stations to an optical transmission line.

For an optical fiber used as an optical transmission line, in commercially available wavelength bands, transmission loss of an optical signal in a short wavelength side is larger than that in a long wavelength side, and due to stimulated Raman scattering between signal light components, optical power is transferred from signal light in a short wavelength side to that in a long wavelength side.

For distributed Raman amplification technology, when pump light is supplied from an optical transmitting station or an optical receiving station to an optical transmission line, the desired Raman amplification gain increases with an increase in the repeating distance between the optical transmitting station and optical receiving station.

Therefore, the energy of pump light moves to signal light in the vicinity of an incidence end for pump light, and so-called pump-depletion occurs. As a result, pump light with sufficient power may be unable to reach the vicinity of the center of the optical transmission line, and the OSNR of the optical transmission system may decrease. In particular, this phenomenon is very common when forward pumping in which the Raman amplification action occurs in a region where the power of signal light input to the optical transmission line is relatively large is used.

For Raman amplification technology, when a plurality of pump lights having different wavelengths are used, a pump light with a short wavelength may Raman-amplify a pump light with a long wavelength. That is, the interaction in which the energy of a pump light with a short wavelength is transferred to a pump light with a long wavelength may occur between the pump lights.

In particular, in the case of forward pumping in which pump light enters the optical transmission line from the incidence end for signal light or backward pumping in which pump light enters the optical transmission line from the exit end for signal light, because the optical power of the pump light with each wavelength at the incidence end for pump light is relatively large, the interaction between pump lights is significantly large.

One example of power distribution of pump lights having different wavelengths when they enter the optical transmission line from the exit end for signal light is illustrated in FIG. 2. In FIG. 2, the horizontal axis indicates the length (distance) of the optical transmission line in the longitudinal direction, and the vertical axis indicates the power of each pump light.

As illustrated in FIG. 2, the pump light power P1 in a short wavelength side indicated by the solid line tends to decrease more sharply at the incidence end for pump light, compared with the pump light power P2 in a long wavelength side indicated by the dot-dash line.

As described above, in a traditional optical transmission system that uses distributed Raman amplification technology, in particular, the OSNR in a short wavelength side in signal light wavelength bands may decrease significantly.

As illustrated in FIG. 3, depending on the wavelength arrangement of pump light and signal light, a pump light with a short wavelength may Raman-amplify not only signal light but also a pump light with a long wavelength.

International Publication Pamphlet No. WO 2002/017010 mentioned above does not discuss reduction in the interaction between pump lights. It is difficult for the technique described in International Publication Pamphlet No. WO 2002/017010 to suppress a decrease in OSNR in a short wavelength side in signal light wavelength bands and to control flattening the Raman amplification gain.

### SUMMARY

According to an aspect of the embodiments, an optical transmission system for communicating between transmission devices includes a first pump light source that supplies a first pump light, a second pump light source that supplies a second pump light, an optical transmission line that propagates an optical signal between the transmission devices, and a plurality of couplers that form a plurality of zones in the transmission line, the first pump light source and the second pump light source being optically connected to different couplers of the plurality of couplers, the second pump light Raman-amplifying the first pump light in a zone in which the second pump light is input in the transmission line.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example of the configuration of an optical transmission system that uses WDM optical transmission technology;

FIG. 2 illustrates one example of distribution of power of pump light;

FIG. 3 illustrates one example of wavelength arrangement of pump light and signal light and power transition caused by Raman amplification;

FIG. 4 illustrates one example of the configuration of an optical transmission system according to an embodiment;

FIG. 5 illustrates one example of the configuration of an optical transmission system according to a first variation;

FIG. 6 illustrates one example of the configuration of an optical transmission system according to a second variation;

FIG. 7 illustrates one example of the configuration of an optical transmission system according to a third variation;

FIG. 8 illustrates one example of the configuration of an optical transmission system according to a fourth variation;

FIG. 9 illustrates one example of the configuration of an optical transmission system according to a fifth variation;

FIG. 10 illustrates one example of the configuration of an optical transmission system according to a sixth variation;

FIG. 11 illustrates one example of the configuration of an optical transmission system according to a seventh variation;

FIG. 12 illustrates one example of the configuration of an optical transmission system according to an eighth variation;

FIG. 13 illustrates one example of the configuration of an optical transmission system according to a ninth variation;

FIGS. 14A to 14D illustrate examples of core arrangement in a multi-core optical fiber;

FIG. 15 illustrates one example of the configuration of an optical transmission system according to an 11th variation;

FIGS. 16A to 16C illustrate examples of inter-core coupling techniques in the optical transmission system illustrated in FIG. 15;

FIGS. 17A to 17C illustrate examples of inter-core coupling techniques in the optical transmission system illustrated in FIG. 15; and

FIG. 18 illustrates one example of the configuration of an optical transmission system according to a 13th variation.

### DESCRIPTION OF EMBODIMENT

An embodiment is described below with reference to the drawings. The embodiment described below is merely illustrative and not intended to preclude various modifications and technical applications that are not clearly demonstrated in the embodiment and variations described below. That is, various modifications of the embodiment and variations described below without departing from the scope of the disclosure may be made.

### [1] Embodiment

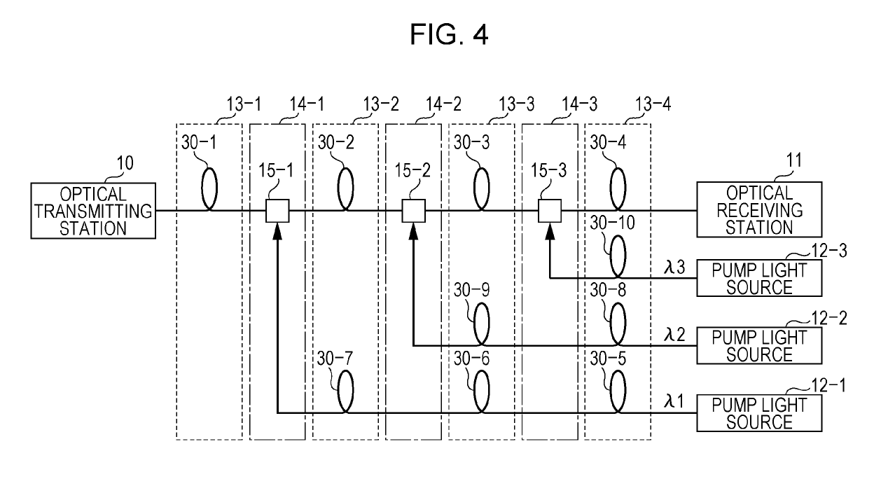

FIG. 4 illustrates one example of the configuration of an optical transmission system according to an embodiment.

The optical transmission system illustrated in FIG. 4 may include an optical transmitting station 10, an optical receiving station 11, transmission sections 13-1, 13-2, 13-3, and 13-4, multiplexing sections 14-1, 14-2, and 14-3, and a plurality of pump light sources 12-1 to 12-3. The configuration of the optical transmission system illustrated in FIG. 4 is merely an example. The number of the transmission sections, the number of the multiplexing sections, and the number of the pump light sources are not limited to the numbers described in the example illustrated in FIG. 4.

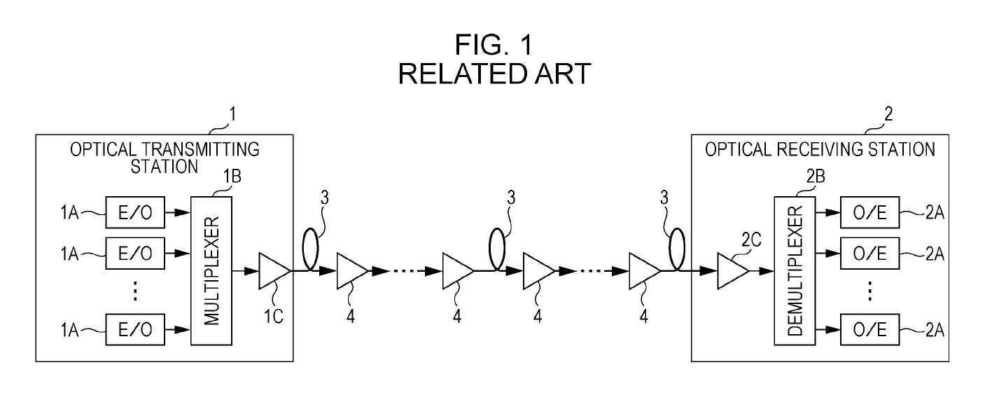

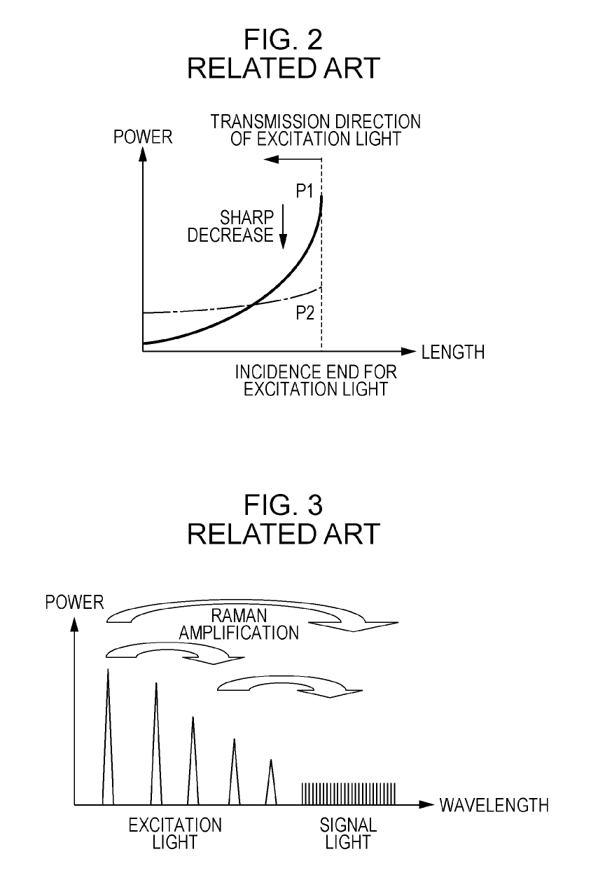

The optical transmitting station 10 functions as one example of a first optical transmission device configured to transmit an optical signal. The optical transmitting station 10 may include a plurality of optical transmitters 1A for outputting respective signal light components having different wavelengths, a multiplexer 1B for multiplexing the wavelengths of the signal light components, and a post-amplifier 1C for amplifying WDM light output from the multiplexer 1B to a given level and sending the WDM light to the optical transmission line 3, for example, as in the case of the optical transmitting station 1 illustrated in FIG. 1.

An optical signal transmitted from the optical transmitting station 10 passes through the transmission section 13-1, multiplexing section 14-1, transmission section 13-2, multiplexing section 14-2, transmission section 13-3, multiplexing section 14-3, and transmission section 13-4 and is received by the optical receiving station 11.

The transmission section 13-1 includes an optical transmission line 30-1. The transmission section 13-2 includes optical transmission lines 30-2 and 30-7. The transmission section 13-3 includes optical transmission lines 30-3, 30-6, and 30-9. The transmission section 13-4 includes optical transmission lines 30-4, 30-5, 30-8, and 30-10.

The multiplexing section 14-1 includes an optical coupler 15-1. The multiplexing section 14-2 includes an optical coupler 15-2. The multiplexing section 14-3 includes an optical coupler 15-3.

As described above, the optical couplers 15-1 to 15-3 are disposed in different locations in the optical transmission lines 30-1 to 30-4. That is, the optical couplers 15-1 to 15-3 form a plurality of zones in the optical transmission lines 30-1 to 30-4 in cooperation with the optical transmitting station 10 and optical receiving station 11.

In the optical transmission system configured as illustrated in FIG. 4, an optical signal transmitted from the optical transmitting station 10 passes through the optical transmission line 30-1, optical coupler 15-1, optical transmission line 30-2, optical coupler 15-2, optical transmission line 30-3, optical coupler 15-3, and optical transmission line 30-4 and is received by the optical receiving station 11. In this way, an optical signal transmitted from the optical transmitting station 10 passes through the optical transmission lines 30-1 to 30-4 and reaches the optical receiving station 11 without passing through an optical repeating device that performs 3R regeneration, for example.

The optical receiving station 11 functions as one example of a second optical transmission device configured to receive an optical signal transmitted from the optical transmitting station 10 through the optical transmission lines 30-1 to 30-4. The optical receiving station 11 may include a pre-amplifier 2C for receiving WDM light from the optical transmitting station 10 and amplifying it to a given level, a demultiplexer 2B for demulitiplexing the amplified WDM light for each wavelength, and a plurality of optical receivers 2A for performing predetermined reception processing on the demultiplexed signal light components, for example, as in the case of the optical receiving station 2 illustrated in FIG. 1.

The pump light sources 12-1 to 12-3 supply pump lights having different wavelengths λ1 to λ3 for Raman-amplifying an optical signal by employing the optical transmission lines 30-1 to 30-4 as an amplification medium. In the example illustrated in FIG. 4, the wavelength of each pump light is a single wavelength λ1, λ2, or λ3. At least any one of the pump lights may be a pump light in a wavelength band that has a plurality of wavelengths.

For example, the pump light source 12-1 outputs a pump light having the wavelength λ1. The pump light with the wavelength λ1 output from the pump light source 12-1 passes through the optical transmission lines 30-5, 30-6, and 30-7 for pump light and is made to enter the optical transmission line 30-1 for optical signals by the optical coupler 15-1. That is, the pump light with the wavelength λ1 supplied from the pump light source 12-1 Raman-amplifies an optical signal by employing the optical transmission line 30-1 as an amplification medium by backward pumping.

For example, the pump light source 12-2 outputs a pump light having the wavelength λ2 (>λ1). The pump light with the wavelength λ2 output from the pump light source 12-2 passes through the optical transmission lines 30-8 and 30-9 for pump light and is made to enter the optical transmission line 30-2 for optical signals by the optical coupler 15-2. That is, the pump light with the wavelength λ2 supplied from the pump light source 12-2 Raman-amplifies an optical signal by employing the optical transmission line 30-2 as the amplification medium by backward pumping. After Raman-amplifying an optical signal by employing the optical transmission line 30-2 as the amplification medium, the pump light with the wavelength λ2 supplied from the pump light source 12-2 may reach the optical transmission line 30-1 and Raman-amplify an optical signal by employing the optical transmission line 30-1 as an amplification medium.

For example, the pump light source 12-3 outputs a pump light having the wavelength λ3 (>λ2). The pump light with the wavelength λ3 output from the pump light source 12-3 passes through the optical transmission line 30-10 for pump light and is made to enter the optical transmission line 30-3 for optical signals by the optical coupler 15-3. That is, the pump light with the wavelength λ3 supplied from the pump light source 12-3 Raman-amplifies an optical signal by employing the optical transmission line 30-3 as the amplification medium by backward pumping. After Raman-amplifying an optical signal by employing the optical transmission line 30-3 as the amplification medium, the pump light with the wavelength λ3 supplied from the pump light source 12-3 may reach the optical transmission line 30-2 or optical transmission line 30-1 and Raman-amplify an optical signal by employing the optical transmission line 30-2 or optical transmission line 30-1 as an amplification medium.

The pump light sources 12-1 to 12-3 are disposed in any of the optical receiving station 11, optical transmitting station 10, another station, and another device. For example, in terms of cost reduction of the system, the pump light sources 12-1 to 12-3 may preferably be disposed in locations where the lengths of the optical transmission lines 30-5 to 30-10 to the optical couplers 15-1 to 15-3 are small.

The example illustrated in FIG. 4 is based on wavelength arrangement of pump lights at which there is a possibility that an interaction occurs between the pump light with the wavelength the wavelength λ1 and either one of the pump light with the wavelength λ2 and that with the wavelength λ3 and there is a possibility that an interaction occurs between the pump light with the wavelength λ2 and that with the wavelength λ3.

In the optical transmission system illustrated in FIG. 4, among the pump lights supplied from the plurality of pump light sources 12-1 to 12-3, a first pump light that Raman-amplifies a second pump light and the second pump light enter the optical transmission lines 30-1 to 30-4 so as not to Raman-amplify an optical signal by employing the same zone in the optical transmission lines 30-1 to 30-4 as the amplification medium.

That is, the pump lights with the wavelengths λ1 to λ3 in the wavelength arrangement where an interaction may occur between the pump lights enter the optical transmission lines 30-1 to 30-4 so as to Raman-amplify an optical signal by employing different zones in the optical transmission lines 30-1 to 30-4 as the amplification medium.

As described above, in the present embodiment, because the interaction between pump lights is reduced, Raman amplification gain may be obtained efficiently.

From the fact that the transmission loss of an optical signal in a short wavelength side is larger than that of an optical signal in a long wavelength side in the optical transmission lines 30-1 to 30-4 and the fact that a decrease in the power of a signal light component with a short wavelength caused by stimulated Raman scattering between the signal light components is also large and from the viewpoint of flattening the OSNR in wavelength bands of the signal light, a pump light with a short wavelength may preferably be multiplexed from an incidence location at which the optical transmitting station 10 is nearer to the pump light with the short wavelength than a pump light with a long wavelength.

That is, the optical transmitting station 10 may preferably be nearer to the incidence location from which a pump light with a short wavelength (λ1 or λ2) among the pump lights supplied from the plurality of pump light sources 12-1 to 12-3 enters the optical transmission lines 30-1 to 30-4 than the incidence location or locations from which a pump light with a long wavelength (λ2) or pump lights with long wavelengths (λ2 and λ3) enter the optical transmission lines 30-1 to 30-4.

From the fact that the transmission loss of an optical signal in a short wavelength side is larger than that of an optical signal in a long wavelength side in the optical transmission lines 30-1 to 30-4 and the fact that a decrease in the power of a signal light component with a short wavelength caused by stimulated Raman scattering between the signal light components is also large and from the viewpoint of flattening the OSNR in wavelength bands of the signal light, the power of a pump light with a short wavelength may preferably be larger than that with a long wavelength.

With that, over wide bands, a flatter level diagram of optical signals may be achieved and the OSNR in the optical transmission system may be improved.

In addition, because the OSNR of an optical signal in a short wavelength side may be improved and the interaction between pump lights may be reduced, flattening gain characteristics in Raman amplification may be easily controlled.

[2] First Variation

The example illustrated in FIG. 4 is based on the assumption that the pump light with the wavelength λ2 output from the pump light source 12-2 and the pump light with the wavelength λ3 output from the pump light source 12-3 are sufficiently attenuated in the optical transmission lines 30-2 and 30-3, respectively, and do not reach the optical transmission lines 30-1 and 30-2.

However, depending on the power of each pump light, there may be cases where the pump light with the wavelength λ2 output from the pump light source 12-2 reaches the optical transmission line 30-1 or the pump light with the wavelength λ3 output from the pump light source 12-3 reaches the optical transmission lines 30-2 and 30-1. In such cases, an interaction between pump lights may occur.

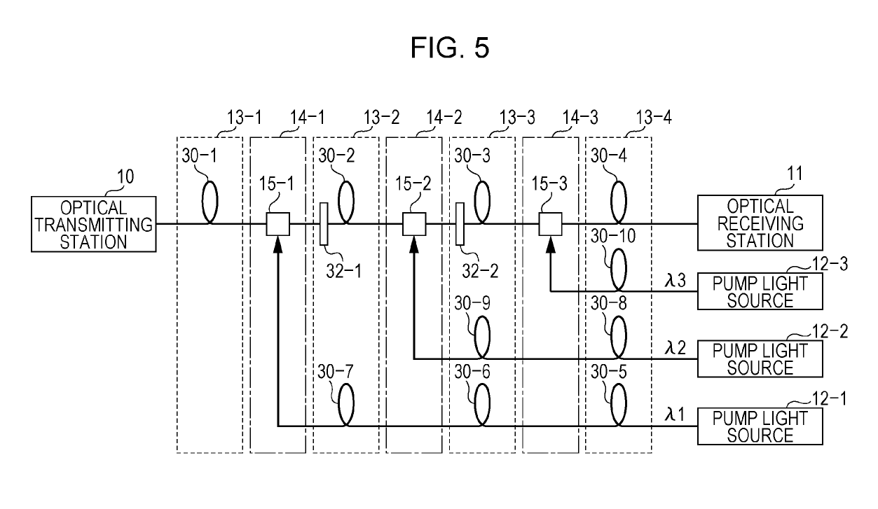

To address such cases, the optical transmission system may include at least one optical filter for blocking pump lights in wavelength arrangement at which an interaction between pump lights occurs from entering the same zone. One example of such an optical transmission system is illustrated in FIG. 5. The illustrated optical transmission system includes two optical filters 32-1 and 32-2. In FIG. 5, the elements having the same reference numerals as in FIG. 4 have substantially the same functions as in the elements illustrated in FIG. 4, and the description thereof is omitted here.

For example, the optical filter 32-1 is disposed between the optical transmission line 30-2 and the optical coupler 15-1 and functions as a band-pass filter or a high-pass filter that has a filter characteristic in which the pump light with the wavelength λ2 is blocked and an optical signal is transmitted to pass.

For example, the optical filter 32-2 is disposed between the optical transmission line 30-3 and the optical coupler 15-2 and functions as a band-pass filter or a high-pass filter that has a filter characteristic in which the pump light with the wavelength λ3 is blocked and an optical signal is transmitted to pass.

The present variation may provide substantially the same advantageous effects as in the embodiment previously described with reference to FIG. 4 and also reliably reduce the occurrence of interactions between pump lights.

[3] Second Variation

The examples illustrated in FIGS. 4 and 5 is base on the case where an interaction between the pump lights with the wavelengths λ1, λ2, and λ3 occurs, and the pump lights enter the optical transmission lines 30-1 to 30-4 from different incidence locations. However, depending on the wavelength arrangement of pump lights, there may be a case where an interaction does not occur between parts of the pump lights. In such a case, for example, the parts of the pump lights may be multiplexed before entering the optical transmission lines 30-1 to 30-4.

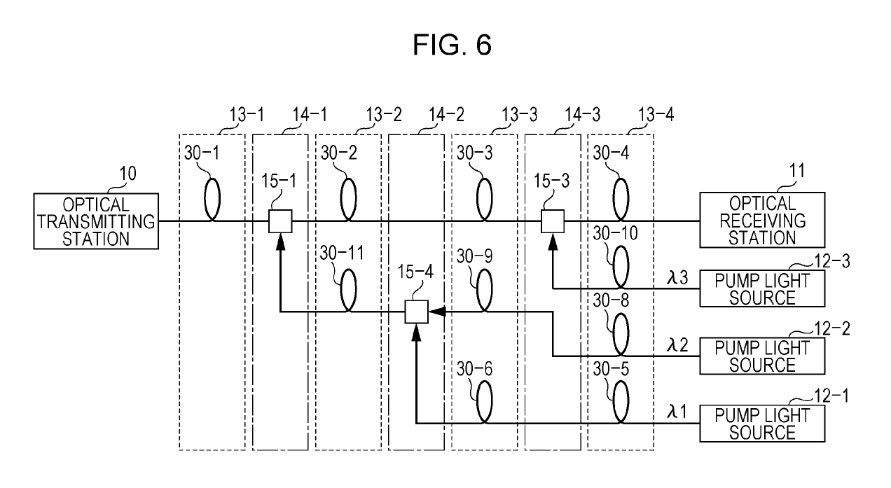

FIG. 6 illustrates one example of the configuration of an optical transmission system according to a second variation. In FIG. 6, the elements having the same reference numerals as in FIG. 4 have substantially the same functions as in the elements illustrated in FIG. 4, and the description thereof is omitted here.

The optical transmission system illustrated in FIG. 6 is based on the case where no interaction occurs between the pump light with the wavelength λ1 and that with the wavelength λ2 and an interaction occurs between the pump light with the wavelength λ1 and that with the wavelength λ3 and between the pump light with the wavelength λ2 and that with the wavelength λ3, for example.

In this case, as illustrated in FIG. 6, the pump light with the wavelength λ1 and that with the wavelength λ2 may be multiplexed by an optical coupler 15-4 disposed in a route different from the optical transmission lines 30-1 to 30-4 through which an optical signal passes and then sent to the optical coupler 15-1 through an optical transmission line 30-11, and the multiplexed pump light may enter the optical transmission line 30-1 or 30-2. In this case, the pump light with the wavelength λ3, in which an interaction occurs with the multiplexed pump light of the pump light with the wavelength λ1 and that with the wavelength λ2, may preferably enter the optical transmission line 30-3 or 30-4 through the optical transmission line 30-10 and the optical coupler 15-3 so as to pass through a transmission zone different from the transmission section through which the multiplexed pump light passes.

The present variation may provide substantially the same advantageous effects as in the embodiment previously described with reference to FIG. 4 and also offer an advantage of an improved degree of freedom in the design of the optical transmission system.

[4] Third Variation

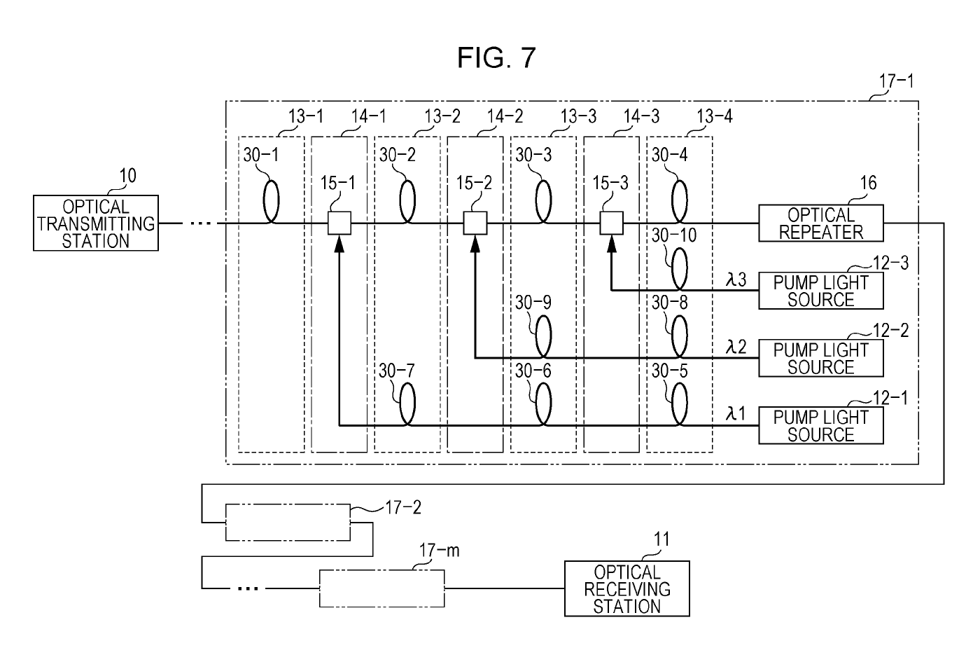

As illustrated in FIG. 7, at least one optical repeater 16 may be disposed between the optical transmitting station 10 and the optical receiving station 11.

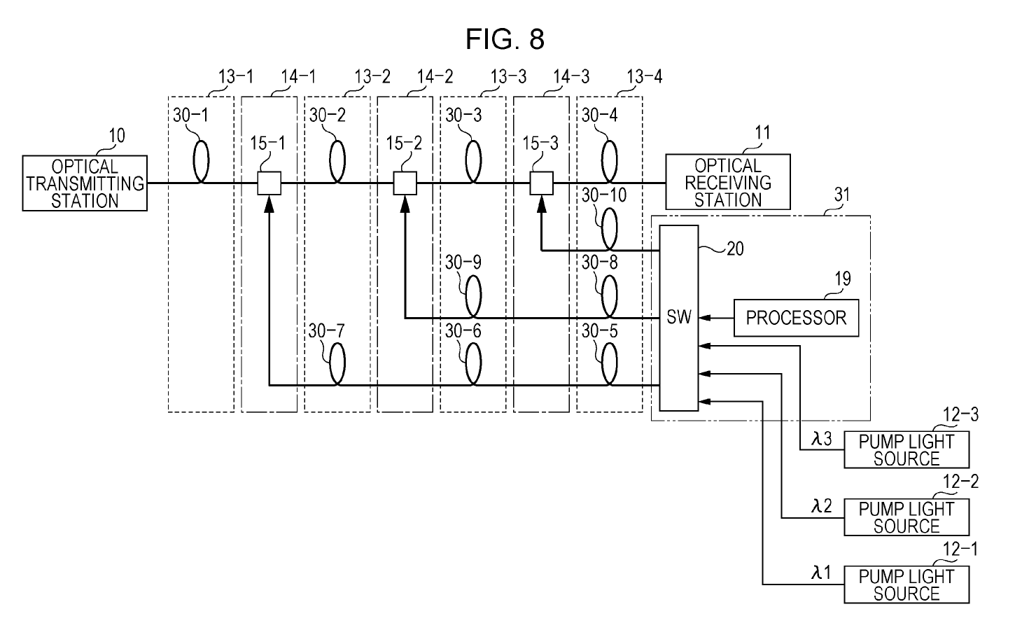

In this case, the configuration illustrated in any of FIGS. 4 to 6 and the configuration illustrated in any of FIGS. 8 to 13 and 15 may be used in combination in between the optical transmitting station 10 and the optical repeater 16, between the optical repeaters 16, and between the optical repeater 16 and the optical receiving station 11 (for each repeating span), for example. That is, the internal configurations of optical processing units indicated by the reference numerals 17-1, 17-2, . . . , 17-m (m is a natural number) in FIG. 7 may be the same or different in part. In FIG. 7, the elements having the same reference numerals as in FIG. 4 have substantially the same functions as in the elements illustrated in FIG. 4, and the description thereof is omitted here.

That is, when the portion between the optical transmitting station 10 and the optical repeater 16 is discussed, the optical transmitting station 10 functions as one example of a first optical transmission device and the optical repeater 16 functions as one example of a second optical transmission device. When the portion between the optical repeaters 16 is discussed, the optical repeater 16 adjacent to the optical transmitting station 10 functions as one example of a first optical transmission device and the optical repeater 16 adjacent to the optical receiving station 11 functions as one example of a second optical transmission device. When the portion between the optical repeater 16 and the optical receiving station 11 is discussed, the optical repeater 16 functions as one example of a first optical transmission device and the optical receiving station 11 functions as one example of a second optical transmission device.

The optical repeater 16 includes a device that performs 3R regeneration of re-amplification, re-timing, and re-shaping in the state where signal light is converted into an electrical signal, then converts the electrical signal into signal light, and sends it to the optical receiving station 11 and a device that performs various kinds of repeating processing on signal light remaining in light state and sends it toward the optical receiving station 11, for example.

The present variation may provide the optical transmission system including at least one optical repeater 16 between the optical transmitting station 10 and the optical receiving station 11 with substantially the same advantageous effect as in the embodiment previously described with reference to FIG. 4.

[5] Fourth Variation

The optical transmission system may use a processing apparatus (pump light supply apparatus) 31 that determines to which of the optical couplers 15-1 to 15-3 pump lights from the plurality of pump light sources 12-1 to 12-3 are to be supplied.

For example, the optical transmission system illustrated in FIG. 8 includes the processing apparatus 31 for controlling switching of the incidence location of each pump light, in addition to the elements in the optical transmission system illustrated in FIG. 4. In FIG. 8, the elements having the same reference numerals as in FIG. 4 have substantially the same functions as in the elements illustrated in FIG. 4, and the description thereof is omitted here.

The processing apparatus 31 may include a processing portion (processor) 19 and a switch (SW) 20.

The SW 20 switches the destinations of pump lights from the pump light sources 12-1 to 12-3 according to the control by the processor 19.

The processor 19 supplies each pump light to any one of the plurality of optical couplers 15-1 to 15-3 by controlling the SW 20 so as to enable a first pump light that Raman-amplifies a second pump light and the second pump light to Raman-amplify an optical signal by employing different zones out of the plurality of zones 30-1 to 30-4 as the amplification medium, the first pump light and the second pump light being among the pump lights supplied from the plurality of pump light sources 12-1 to 12-3.

The present variation may provide substantially the same advantageous effects as in the embodiment previously described with reference to FIG. 4.

In the example illustrated in FIG. 8, the number of the pump-light wavelengths and the number of the incidence locations are the same. The present variation is not limited to this example. For example, the present variation is also applicable to the case where the number of the incidence locations (that is, the number of the optical couplers) is larger than the number of the pump-light wavelengths (that is, the number of the pump light sources). In this case, in particular, the incidence location of each pump light may be determined suitably.

[6] Fifth Variation

Which pump-light wavelength is incident from which incidence location (optical coupler 15-1, 15-2, or 15-3) may be determined, for example, on the basis of a result of monitoring of the quality of reception of an optical signal, for example.

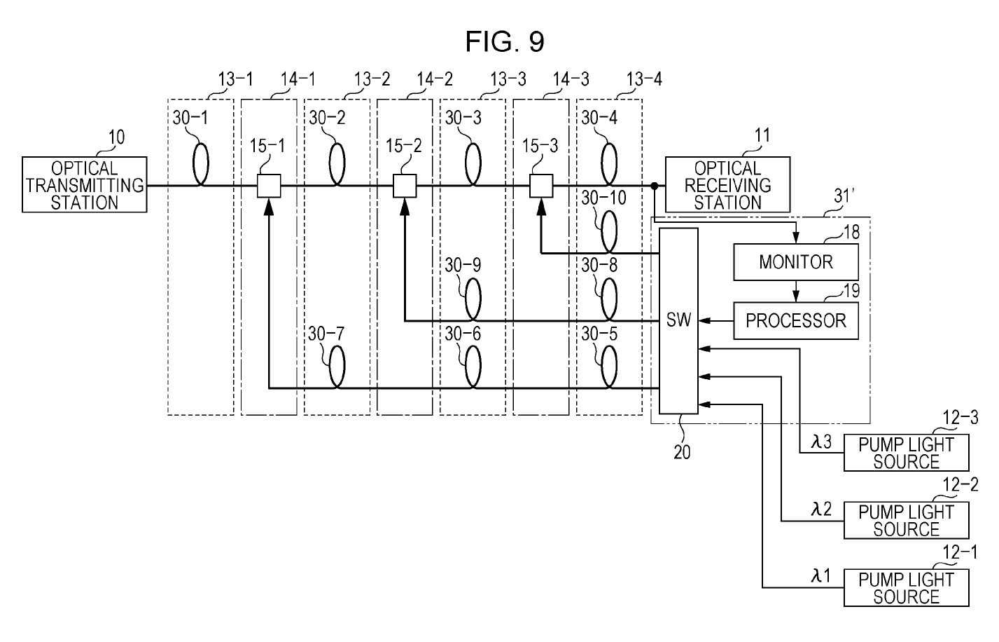

For example, the optical transmission system illustrated in FIG. 9 includes a processing apparatus (pump light supply apparatus) 31′ for controlling switching of the incidence location of each pump light, in addition to the elements in the optical transmission system illustrated in FIG. 4. In FIG. 9, the elements having the same reference numerals as in FIG. 8 have substantially the same functions as in the elements illustrated in FIG. 8, and the description thereof is omitted here.

The processing apparatus 31′ may include a monitor 18, the processor 19, and the SW 20.

The monitor 18 monitors the quality of reception of an optical signal received by the optical receiving station 11. Examples of the quality of reception monitored by the monitor 18 may include OSNR and the power level of signal light.

The processor 19 controls the SW 20 on the basis of a result of monitoring by the monitor 18.

The SW 20 switches the destinations of pump lights from the pump light sources 12-1 to 12-3 according to the control by the processor 19.

One example of a method of control by the processor 19 is described below. First, the pump light with the wavelength λ2 and that with the wavelength λ3 are blocked by the SW 20, only the incidence location of the pump light with the wavelength λ1 is switched, and the incidence location of the pump light with the wavelength λ1 at which the quality of reception of an optical signal is highest is determined.

Then, the pump light with the wavelength λ3 is blocked by the SW 20, only the incidence location of the pump light with the wavelength λ2 is switched, and the incidence location of each of the pump light with the wavelength λ1 and that with the wavelength λ2 at which the quality of reception of an optical signal is highest is determined. In the case where an interaction occurs between the pump light with the wavelength λ1 and that with the wavelength λ2, the incidence location of the pump light with the wavelength λ2 may preferably be selected from among incidence locations different from the incidence location of the pump light with the wavelength λ1.

Then, the incidence location of the pump light with the wavelength λ3 is switched, and the incidence location of each of the pump light with the wavelength λ1, that with the wavelength λ2, and that with the wavelength λ3 at which the quality of reception of an optical signal is highest is determined. In the case where an interaction occurs between the pump light with the wavelength λ3 and another pump light, the incidence location of the pump light with the wavelength λ3 may preferably be selected from among incidence locations different from the incidence location of the other pump lights.

Because the incidence location of each pump light is determined on the basis of the quality of reception of an optical signal, the present variation may provide substantially the same advantageous effects as in the embodiment previously described with reference to FIG. 4 and also reliably improve the quality of reception of an optical signal.

In the example illustrated in FIG. 9, the number of the pump-light wavelengths and the number of the incidence locations are the same. The present variation is not limited to this example. For example, the present variation is also applicable to the case where the number of the incidence locations (that is, the number of the optical couplers) is larger than the number of the pump-light wavelengths (that is, the number of the pump light sources). In this case, in particular, the incidence location of each pump light may be determined suitably.

[7] Sixth Variation

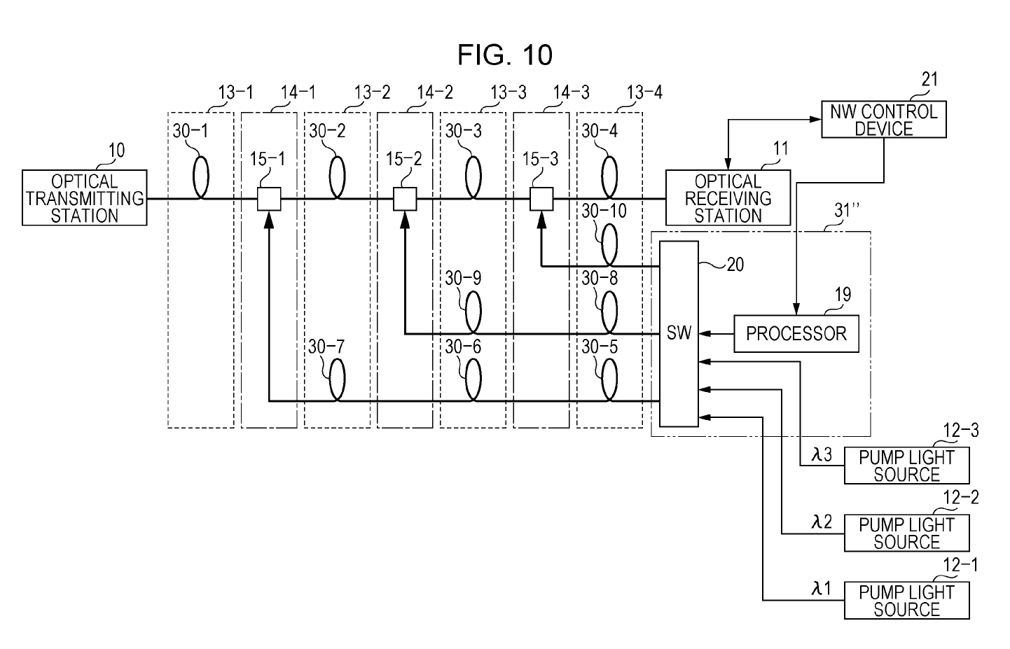

As illustrated in FIG. 10, the incidence location of each pump light may be determined on the basis of information on the quality of reception of an optical signal received from a network (NW) control device 21 for monitoring the optical transmission system.

In this case, as illustrated in FIG. 10, for example, a processing apparatus (pump light supply apparatus) 31″ including the processor 19 and the SW 20 may receive information on the quality of reception of an optical signal from the NW control device 21 for monitoring the optical transmission system and determine the incidence location of each pump light on the basis of the information. The information on the quality of reception of an optical signal may be obtained by the optical receiving station 11 and may be transmitted from the optical receiving station 11 to the NW control device 21. Alternatively, it may be obtained from the exit end in the optical transmission line 30-4 or other location by the NW control device 21. In FIG. 10, the elements having the same reference numerals as in FIG. 9 have substantially the same functions as in the elements illustrated in FIG. 9, and the description thereof is omitted here.

Because the monitor 18 may be omitted from the processing apparatus 31′, the present variation may provide substantially the same advantageous effects as in the fifth variation described with reference to FIG. 9, and the configuration of the optical transmission system may be further simplified.

[8] Seventh Variation

The example illustrated in FIG. 6 is based on the case where no interaction occurs between the pump light with the wavelength λ1 and that with the wavelength λ2, an interaction occurs between the pump light with the wavelength λ1 and that with the wavelength λ3 and between the pump light with the wavelength λ2 and that with the wavelength λ3, and the pump light with the wavelength λ1 and that with the wavelength λ2 are multiplexed before entering the optical transmission lines 30-1 to 30-4. In such a case, the pump light with the wavelength λ2 may be split before being multiplexed with the pump light with the wavelength λ1, and the split pump light may enter the optical transmission line 30-2 or 30-3.

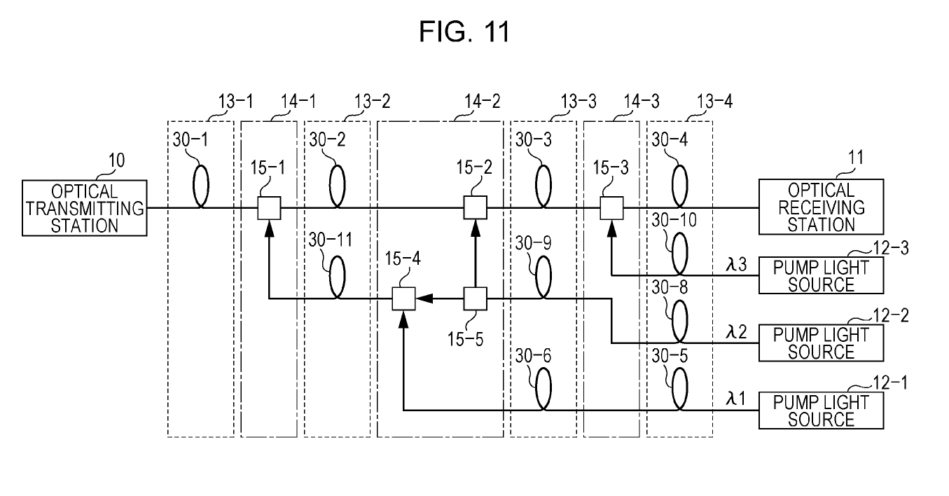

For example, the optical transmission system illustrated in FIG. 11 includes an optical coupler 15-5 for splitting the pump light with the wavelength λ2 before it is multiplexed with the pump light with the wavelength λ1 and the optical coupler 15-2 for making the pump light with the wavelength λ2 split by the optical coupler 15-5 enter the optical transmission line 30-2 or 30-3. In FIG. 11, the elements having the same reference numerals as in FIG. 6 have substantially the same functions as in the elements illustrated in FIG. 6, and the description thereof is omitted here. In this case, the pump light with the wavelength λ3 may preferably enter the optical transmission line 30-3 or 30-4 through the optical transmission line 30-10 and the optical coupler 15-3 so as to pass through a transmission zone different from the transmission zone through which the other pump lights pass.

The present variation may provide substantially the same advantageous effects as in the embodiment previously described with reference to FIG. 4 and also offer an advantage of an improved degree of freedom in the design of the optical transmission system.

Depending on the wavelength arrangement of pump lights, the use of the configuration of the optical transmission system illustrated in FIG. 11 may enable the pump light with the wavelength λ3 to be amplified by the pump light with the wavelength λ2 and enables the pump light with the wavelength λ2 to be amplified by the pump light with the wavelength λ1 and then enter the optical transmission line 30-1 or 30-2. Thus the degree of freedom in the design of the optical transmission system is further improved.

[9] Eighth Variation

A multi-core optical fiber including a plurality of cores through which optical signals and pump lights pass may be used in the optical transmission lines 30-1 to 30-11.

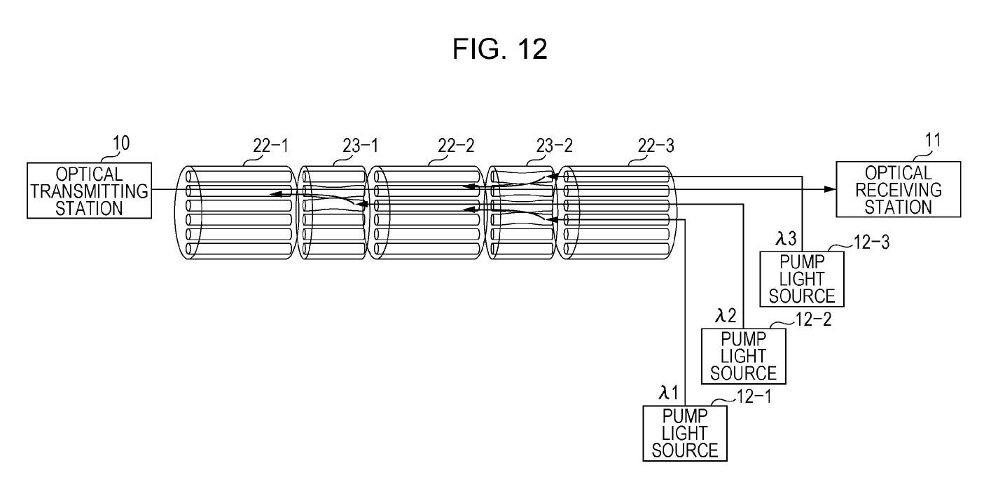

The optical transmission system illustrated in FIG. 12 achieves substantially the same optical transmission system as in FIG. 6 by using multi-core optical fibers 22-1 to 22-3 as the optical transmission lines 30-1 to 30-6 and 30-8 to 30-11. In FIG. 12, the elements having the same reference numerals as in FIG. 6 have substantially the same functions as in the elements illustrated in FIG. 6, and the description thereof is omitted here.

In the example illustrated in FIG. 12, an optical signal output from the optical transmitting station 10 passes through a core (also referred to as optical-signal core) in the multi-core optical fibers 22-1 to 22-3. Each of the pump lights with the wavelengths λ1 to λ3 is incident through a core different from the core through which an optical signal passes (also referred to as pump-light core) out of the plurality of cores included in the multi-core optical fiber 22-3.

The pump light passing through each of the pump-light cores is made to enter the optical-signal core by inter-core coupler 23-1 or 23-2 for coupling the cores within the multi-core optical fibers 22-1 to 22-3.

For example, the pump light with the wavelength λ3 output from the pump light source 12-3 passes through a pump-light core in the multi-core optical fiber 22-3, then is made to enter an optical-signal core by the inter-core coupler 23-2, and Raman-amplifies an optical signal.

The pump light with the wavelength λ1 output from the pump light source 12-1 passes through a pump-light core in the multi-core optical fiber 22-3 and then is made to enter the pump-light core through which the pump light with the wavelength λ2 output from the pump light source 12-2 passes by the inter-core coupler 23-2. Then, the pump light in which the pump light with the wavelength λ1 and that with the wavelength λ2 are multiplexed by the inter-core coupler 23-2 passes through a pump-light core in the multi-core optical fiber 22-2, then is made to enter an optical-signal core by the inter-core coupler 23-1, and Raman-amplifies an optical signal.

The present variation may provide substantially the same advantageous effects as in the embodiment previously described with reference to FIG. 4 and also has an advantage of a reduced diameter of the cable holding the optical fiber because the number of optical fibers may be one.

In the case where a multi-core optical fiber is used as the optical transmission lines 30-1 to 30-11, because fusion and connecting connectors enable the portion between optical terminal stations to be collectively connected, the present variation has an advantage that insertion and installation of each element is facilitated.

In addition, relative positional displacement between optical fibers that would be caused by bending of the cable may be reduced.

The configuration of the inter-core couplers 23-1 and 23-2 illustrated in FIG. 12 is merely an example. The inter-core couplers 23-1 and 23-2 may have any configuration that has at least the function of coupling light entering a pump-light core to an optical signal in an optical-signal core. That is, examples of the inter-core couplers 23-1 and 23-2 may include a fused coupler formed by deformation of a multi-core optical fiber and a wavelength demultiplexing inter-core coupler formed from a long-period grating structure. In the above example, for the sake of simplifying the description, each core is represented as a one-dimensional model. However, any type of core may be used.

In addition, as in the case of the embodiment and variations previously described, the pump light output from each of the pump light sources 12-1 to 12-3 may be light having a single wavelength or a group of wavelengths.

[10] Ninth Variation

At least part of pump lights may enter an optical-signal core from a direction different from the direction of propagation of a pump light in a pump-light core.

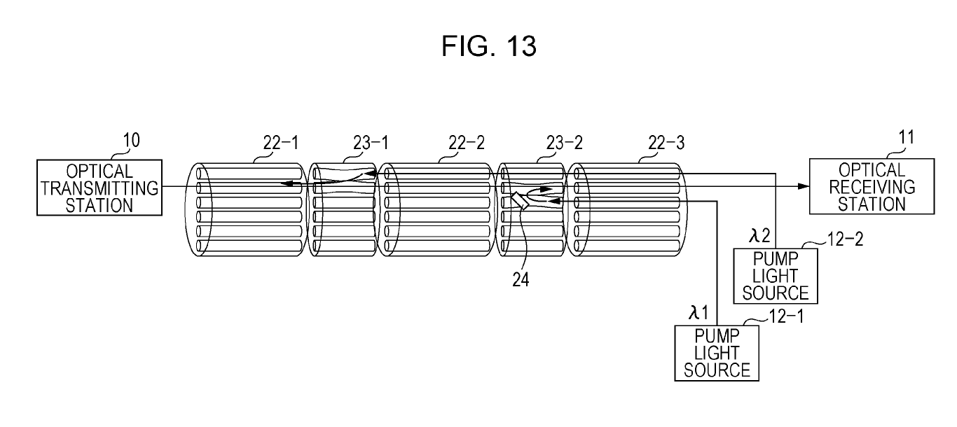

The optical transmission system illustrated in FIG. 13 includes a mirror 24 in a pump-light core in the inter-core coupler 23-2. The mirror 24 reflects a pump light propagating through a pump-light core to an optical-signal core to cause the pump light to enter the optical-signal core from the direction different from the direction of propagation of the pump light in the pump-light core. In FIG. 13, the elements having the same reference numerals as in FIG. 12 have substantially the same functions as in the elements illustrated in FIG. 12, and the description thereof is omitted here. The pump light with the wavelength λ2 may preferably enter an optical-signal core so as to pass through a transmission zone different from the transmission zone of the pump light with the wavelength λ1.

The present variation may provide substantially the same advantageous effects as in the seventh variation previously described with reference to FIG. 11 and also offer an advantage of a further improved degree of freedom in the design of the optical transmission system.

[11] 10th Variation

To facilitate wavelength multiplexing by the inter-core couplers 23-1 and 23-2 in the multi-core optical fibers 22-1 to 22-3 used in the eighth and ninth variations described above, an optical-signal core and a pump-light core may be alternately arranged, for example.

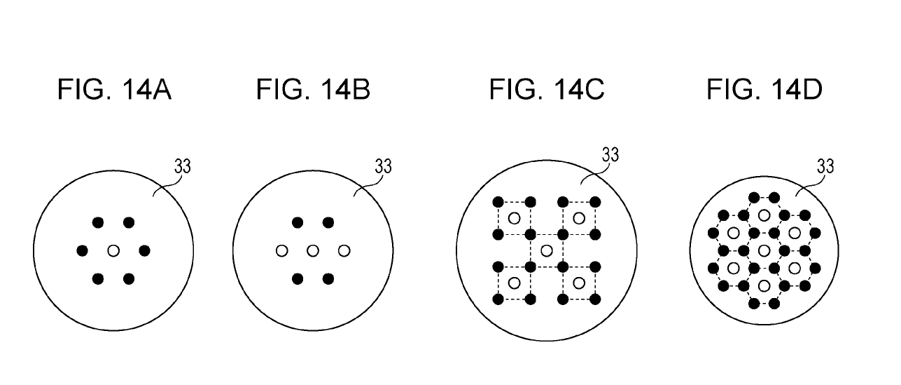

For example, optical-signal cores (see hollow circles in FIGS. 14A to 14D) and pump-light cores (see solid circles in FIGS. 14A to 14D) may preferably be arranged as illustrated in FIGS. 14A to 14D. A clad 33 having a refractive index larger than that of each core is arranged around the optical-signal cores and the pump-light cores.

In all of the examples illustrated in FIGS. 14A to 14D, the cores are alternately arranged such that a plurality of pump-light cores are located at the same distance from an optical-signal core adjacent to the plurality of pump-light cores. The arrangements of cores illustrated in FIGS. 14A to 14D are merely examples; other arrangements may also be used.

In the present variation, because the distance between a pump-light core and an optical-signal core may be minimized, multiplexing by the inter-core couplers 23-1 and 23-2 may be easily performed.

[12] 11th Variation

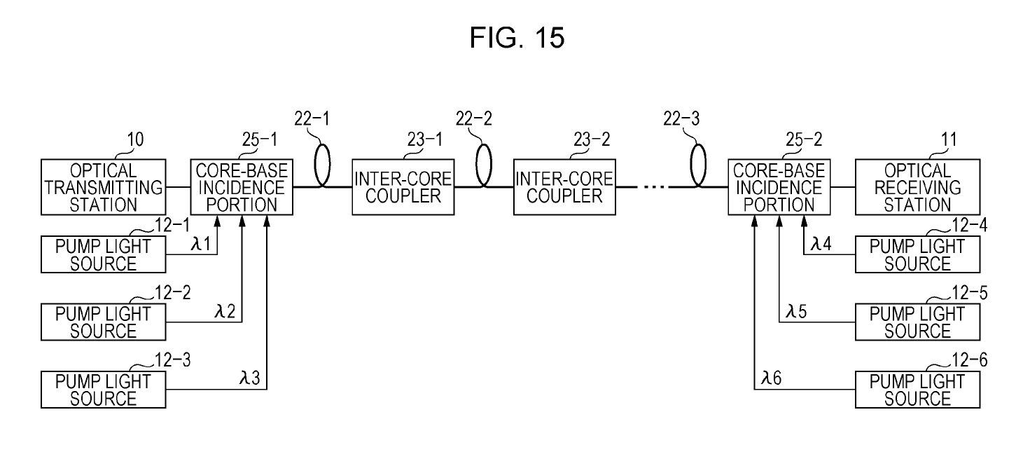

Another example of the optical transmission system using the multi-core optical fibers 22-1 to 22-3 is illustrated in FIG. 15.

The optical transmission system illustrated in FIG. 15 may include the optical transmitting station 10, optical receiving station 11, pump light sources 12-1 to 12-6, multi-core optical fibers 22-1 to 22-3, inter-core couplers 23-1 and 23-2, and core-base incidence portions 25-1 and 25-2. In FIG. 15, the elements having the same reference numerals as in FIG. 12 have substantially the same functions as in the elements illustrated in FIG. 12, and the description thereof is omitted here.

The core-base incidence portion 25-1 makes an optical signal from the optical transmitting station 10 enter an optical-signal core in the multi-core optical fiber 22-1 and also makes pump lights from the pump light sources 12-1 to 12-3 enter respective pump-light cores in the multi-core optical fiber 22-1. That is, in the optical transmission system illustrated in FIG. 15, each of the pump lights with the wavelengths λ1, λ2, and λ3 incident from the pump light sources 12-1 to 12-3 amplifies an optical signal by forward pumping. When the above-described mirror 24 (see FIG. 13) is disposed in either one of the inter-core couplers 23-1 and 23-2, at least one of the pump lights with the wavelengths λ1, λ2, and λ3 may amplify an optical signal by backward pumping.

The core-base incidence portion 25-2 outputs an optical signal output through an optical-signal core in the multi-core optical fiber 22-3 to the optical receiving station 11 and also makes the pump lights from the pump light sources 12-4 to 12-6 enter respective pump-light cores in the multi-core optical fiber 22-3. That is, in the optical transmission system illustrated in FIG. 15, each of the pump lights with the wavelengths λ4 to λ6 (λ1<λ2<λ3<λ4<λ5<λ6) amplifies an optical signal by backward pumping. When the above-described mirror 24 (see FIG. 13) is disposed in either one of the inter-core couplers 23-1 and 23-2, at least one of the pump lights with the wavelengths λ4 to λ6 may amplify an optical signal by forward pumping.

One example of a multiplexing method executed by the inter-core couplers 23-1 and 23-2 is described below.

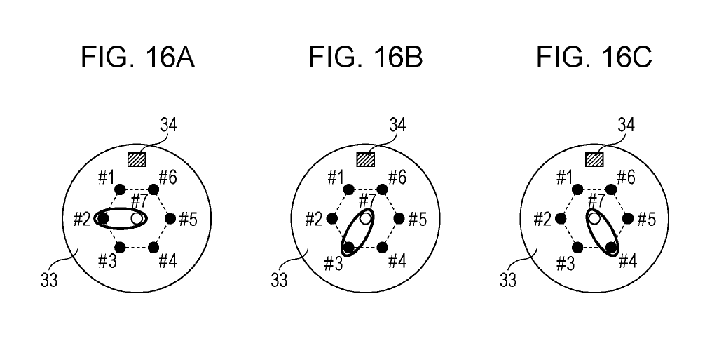

For example, as illustrated in FIGS. 16A to 16C, each of the multi-core optical fibers 22-1 to 22-3 has a marker 34 at a given location, and numbers are assigned to the cores on the basis of the positional relationship relative to the marker 34 in advance. In the examples illustrated in FIGS. 16A to 16C, the pump-light cores have #1 to #6, and the optical-signal core has #7. However, any numbering may also be used.

As illustrated in FIGS. 16A to 16C, the inter-core couplers 23-1 and 23-2 sequentially multiplex pump lights propagating through the pump-light cores having different numbers with an optical signal propagating through the optical-signal core.

At this time, it may be preferable that multiplexing by the inter-core couplers 23-1 and 23-2 be set or the incidence locations in the core-base incidence portions 25-1 and 25-2 be determined such that not a pump light with a long wavelength but that with a short wavelength is multiplexed on a side adjacent to the optical transmitting station 10.

The present variation may provide substantially the same advantageous effects as in the seventh variation previously described with reference to FIG. 11 and the eighth variation previously described with reference to FIG. 12 and also may facilitate a multiplexing action of the inter-core couplers 23-1 and 23-2.

[13] 12th Variation

The 11th variation uses a method of sequentially multiplexing pump lights propagating through the pump-light cores having different numbers with an optical signal propagating through the optical-signal core by the inter-core couplers 23-1 and 23-2. Alternatively, a method of multiplexing pump lights propagating through the pump-light cores having the same number with an optical signal propagating through the optical-signal core may also be used.

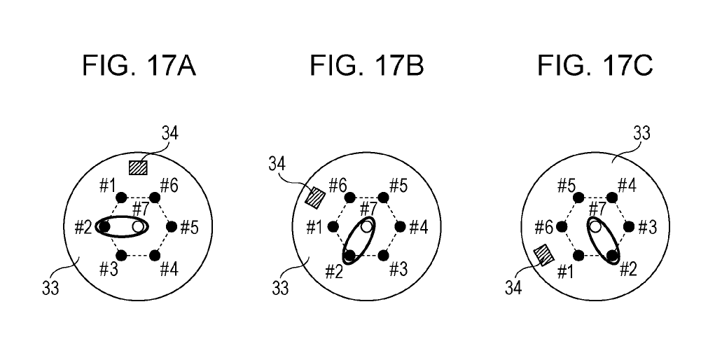

For example, as illustrated in FIGS. 17A to 17C, the connection angle between each of the multi-core optical fibers 22-1 to 22-3 and the inter-core couplers 23-1 and 23-2 may be changed in sequence, and light entering a pump-light core to an optical signal in an optical-signal core that have the same number (for example, #2) may be multiplexed.

For example, in the multi-core optical fibers 22-1 to 22-3 illustrated in FIGS. 17A to 17C, to multiplex light entering the pump-light core #2 and an optical signal in the optical-signal core #7, connecting the multi-core optical fibers 22-1 to 22-3 rotated by 60 degrees on the basis of the marker 34 provided to each of the multi-core optical fibers 22-1 to 22-3 to the inter-core couplers 23-1 and 23-2 may provide a desired multiplexing result.

The present may provide substantially the same advantageous effects as in the 11th variation previously described with reference to FIG. 15. Because the multiplexing function of the inter-core couplers 23-1 and 23-2 may be simplified, the cost of establishing the optical transmission system may be reduced.

[14] 13th Variation

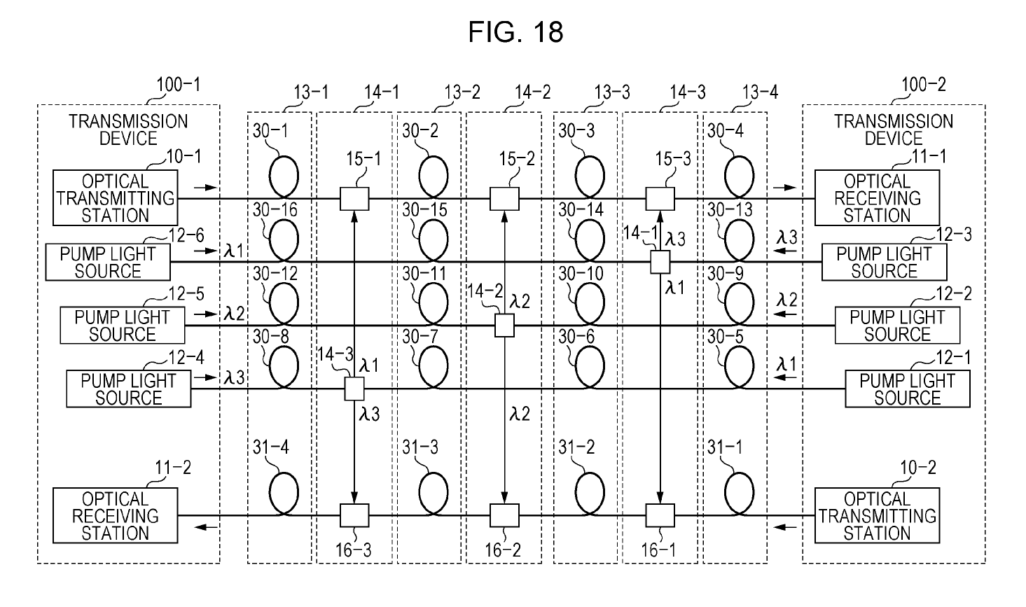

The above-described embodiment discloses the configuration in which the plurality of pump light sources are arranged in the optical receiving station. FIG. 18 illustrates one example of the configuration of the optical transmission system according to a 13th variation. In the variation disclosed in FIG. 18, to amplify signal light by stimulated Raman scattering, a plurality of pump light sources are arranged in each of transmission devices 100-1 and 100-2 opposed to each other. Raman amplification is performed by supplying pump light by backward pumping to signal light propagating through the upstream optical transmission lines 30 and downstream optical transmission lines 31. Alternatively, Raman amplification may be achieved by supplying pump light by forward pumping.

The optical transmission system illustrated in FIG. 18 may include optical transmitting stations 10-1 and 10-2, optical receiving stations 11-1 and 11-2, transmission sections 13-1, 13-2, 13-3, and 13-4, multiplexing sections 14-1, 14-2, and 14-3, and a plurality of pump light sources 12-1 to 12-6. The multiplexing sections 14-1 to 14-3 include the optical couplers 15-1 to 15-3 for supplying pump lights to the optical transmission lines 30-1 to 30-4, two input ports, and two output ports and also includes a wavelength demultiplexing coupler that splits a specific wavelength band input from each input port to a specific port. The wavelength demultiplexing coupler allows pump light input from a first port having a wavelength in a predetermined range to pass therethrough and outputs that having the other wavelengths to a second port. The wavelength demultiplexing coupler also allows pump light input from a third port having a predetermined range to pass therethrough and outputs it to the first port and outputs that having the other wavelengths to a fourth port. More specifically, the wavelength demultiplexing coupler may be a 4-port wavelength division multiplexer (WDM) coupler. When pump lights that would reach the wavelength demultiplexing coupler have the same wavelength, the wavelength demultiplexing coupler may be omitted and the pump lights may be supplied directly to the optical couplers 15-2 and 16-2.

For example, when the pump light sources 12-6 and 12-3 are discussed, the pump light sources 12-6 and 12-3 are disposed in the opposed transmission devices 100-1 and 100-2, respectively, and light components bidirectionally propagate through the optical transmission lines 30-13 to 30-16 for pump light. For example, the wavelength of a pump light emitted from the pump light source 12-6 is λ1 and that from the pump light source 12-3 is λ3. The wavelengths are λ1<λ2<λ3 and thus are different from each other. The pump light output from the pump light source 12-6 and that from the pump light source 12-3 reach a wavelength demultiplexing coupler 14-1 without interacting with each other. The wavelength demultiplexing coupler 14-1 supplies the pump light with the wavelength λ1 to an optical coupler 16-1 and supplies the pump light with the wavelength λ3 to the optical coupler 15-3. The optical couplers 15-3 and 16-1 supply the pump light with the wavelength λ3 and that with the wavelength λ1 to the optical transmission lines 30 and 31, respectively. In substantially the same way, the pump lights from the other pump light sources 12-1, 12-2, 12-4, and 12-5 are supplied to the optical transmission lines 30 and 31.

With the above-described configuration, a phenomenon in which, when a plurality of pump lights propagate through the same optical transmission line in a single direction, the power of light with a short wavelength is transferred to light with a long wavelength may be suppressed, and bidirectional propagation using a multi-core fiber enables a high optical power of pump light to be supplied to the optical transmission line for optical signals.

Therefore, degradation in OSNR of an optical signal may be reduced without increase in the number of fibers.

The configuration of the optical transmission system illustrated in FIG. 18 is merely an example. The number of the transmission sections, that of the multiplexing sections, and that of the pump light sources are not limited to the numbers illustrated in FIG. 18.

[15] Other Applications

The embodiment and variations described above mainly use a backward pumping configuration that introduces pump light from the output side for optical signals into the optical transmission lines 30-1 to 30-4 and 22-1 to 22-3. A forward pumping configuration and a bidirectional pumping configuration may also be used in the embodiment and variations described above.

For example, in the optical transmission system illustrated in FIG. 4, the pump lights with the wavelengths λ1, λ2, and λ3 may enter the optical transmission lines 30-2, 30-3, and 30-4, respectively, through the optical couplers 15-1, 15-2, and 15-3, respectively. In this case, a filter that blocks the pump light with the wavelength λ1 and that allows an optical signal to pass therethrough may be arranged between the optical coupler 15-1 and the optical transmission line 30-2, and a filter that blocks the pump light with the wavelength λ2 and that allows an optical signal to pass therethrough may be arranged between the optical coupler 15-2 and the optical transmission line 30-3.

The pump light with the wavelength λ1 may enter the optical transmission line 30-1 through the optical coupler 15-1, and the pump light with the wavelength λ3 may enter the optical transmission line 30-4 through the optical coupler 15-3, and the pump light with the wavelength λ2 may enter the optical transmission line 30-2 or 30-3 through the optical coupler 15-2. In this case, a filter that blocks the pump light with the wavelength λ2 and that allows an optical signal to pass therethrough may be arranged between the optical coupler 15-1 and the optical transmission line 30-2, or alternatively, a filter that blocks the pump light with the wavelength λ2 and that allows an optical signal to pass therethrough may be arranged between the optical coupler 15-2 and the optical transmission line 30-3.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical transmission system comprising:
a first optical transmission device configured to transmit an optical signal;
an optical transmission line configured to transmit the optical signal to pass therethrough;
a second optical transmission device configured to receive the optical signal through the optical transmission line;
a plurality of pump light sources each configured to supply a pump light that Raman-amplifies the optical signal by employing the optical transmission line as an amplification medium; and
a plurality of optical couplers each configured to make the pump light enter the optical transmission line, the plurality of optical couplers forming a plurality of zones in the optical transmission line in cooperation with the first optical transmission device and the second optical transmission device,
wherein, among the pump lights supplied from the plurality of pump light sources, a first pump light that Raman-amplifies a second pump light and the second pump light enter the optical transmission line so as to Raman-amplify the optical signal in different zones out of the plurality of zones.

2. The optical transmission system according to claim 1, wherein the first optical transmission device is nearer to an incidence location from which a pump light with a short wavelength enters the optical transmission line than an incidence location from which a pump light with a long wavelength enters the optical transmission line, the pump light with the short wavelength and the pump light with the long wavelength being among the pump lights supplied from the plurality of pump light sources.

3. The optical transmission system according to claim 1, further comprising:
a filter configured not to allow the first pump light to enter the zone where the second pump light Raman-amplifies the optical signal or configured not to allow the second pump light to enter the zone where the first pump light Raman-amplifies the optical signal.

4. The optical transmission system according to claim 1, further comprising:
a processing apparatus configured to determine the incidence location of the pump light supplied from each of the plurality of pump light sources on the basis of information on quality of reception of the optical signal.

5. The optical transmission system according to claim 1, wherein the optical transmission line is configured as a multi-core optical fiber that includes at least one optical-signal core that allows the optical signal to pass therethrough and a plurality of pump-light cores that allow each of the pump lights to pass therethrough, and
each of the plurality of optical couplers is configured as an inter-core coupler that multiplexes the pump light to the optical signal in the optical-signal core.

6. The optical transmission system according to claim 5, wherein the inter-core coupler includes a mirror that reflects a pump light propagating through a first pump-light core to a route for a second pump-light core, the first pump-light core and the second pump-light core being among the plurality of pump-light cores, and
a direction of propagation of the pump light propagating through the first pump-light core and a direction of propagation of the reflected pump light propagating through the second pump-light core are opposite to each other.

7. The optical transmission system according to claim 1, wherein the plurality of pump-light cores are located at an equal distance from the optical-signal core being adjacent to the plurality of pump-light cores.

8. A pump-light supply control method for use in an optical transmission system including a first optical transmission device configured to transmit an optical signal, an optical transmission line configured to allow the optical signal to pass therethrough, a second optical transmission device configured to receive the optical signal through the optical transmission line, a plurality of pump light sources each configured to supply a pump light that Raman-amplifies the optical signal by employing the optical transmission line as an amplification medium, and a plurality of optical couplers each configured to make the pump light enter the optical transmission line, the plurality of optical couplers forming a plurality of zones in the optical transmission line in cooperation with the first optical transmission device and the second optical transmission device, the pump-light supply control method comprising:
supplying the pump lights to the plurality of optical couplers so as to enable a first pump light that Raman-amplifies a second pump light and the second pump light to Raman-amplify the optical signal by employing different zones out of the plurality of zones as the amplification medium, the first pump light and the second pump light being among the plurality of pump lights; and
inputting the pump lights from the plurality of pump light sources to the optical transmission line.

9. The pump-light supply control method according to claim 8, wherein the plurality of optical couplers are configured to make a pump light with a short wavelength enter the optical transmission line from an incidence location, the first optical transmission device being nearer to the incidence location of the pump light with the short wavelength than an incidence location from which a pump light with a long wavelength enters the optical transmission line.

10. The pump-light supply control method according to claim 8, wherein the optical transmission system further includes at least one filter, and the at least one filter is configured not to allow the first pump light to enter the zone where the second pump light Raman-amplifies the optical signal or configured not to allow the second pump light to enter the zone where the first pump light Raman-amplifies the optical signal.

11. The pump-light supply control method according to claim 8, wherein the optical transmission system further includes a processing portion configured to determine the incidence location of each of the plurality of pump lights, and the processing portion is configured to determine the incidence location of the pump light supplied from each of the plurality of pump light sources on the basis of information on quality of reception of the optical signal.

12. The pump-light supply control method according to claim 8, wherein the optical transmission line is configured as a multi-core optical fiber that includes at least one optical-signal core that allows the optical signal to pass therethrough and a plurality of pump-light cores that allow the pump light to pass therethrough, and each of the plurality of optical couplers is configured as an inter-core coupler that multiplexes the pump light to the optical-signal core.

13. The pump-light supply control method according to claim 12, wherein the inter-core coupler includes a mirror that reflects the pump light, and
the mirror is configured to reflect a pump light propagating through a first pump-light core to a route for a second pump-light core to cause the reflected pump light to propagate through the second pump-light core in a direction opposite to a direction of propagation of the pump light in the first pump-light core, the first pump-light core and the second pump-light core being among the plurality of pump-light cores.

14. The pump-light supply control method according to claim 12, wherein the plurality of pump-light cores are located at an equal distance from the optical-signal core being adjacent to the plurality of pump-light cores.

15. A pump light supply apparatus in an optical transmission system, comprising:
a first optical transmission device configured to transmit an optical signal;
an optical transmission line configured to transmit the optical signal to pass therethrough;
a second optical transmission device configured to receive the optical signal through the optical transmission line;
a plurality of pump light sources each configured to supply a pump light that Raman-amplifies the optical signal by employing the optical transmission line as an amplification medium;
a plurality of optical couplers each configured to make the pump light enter the optical transmission line, the plurality of optical couplers forming a plurality of zones in the optical transmission line in cooperation with the first optical transmission device and the second optical transmission device;
a switch configured to enable each of the pump lights supplied from the plurality of pump light source to be output to any one of the plurality of optical couplers; and
a processing portion configured to supply each of the pump lights to any one of the plurality of optical couplers by controlling the switch so as to enable a first pump light that Raman-amplifies a second pump light and the second pump light to Raman amplify the optical signal by employing different zones out of the plurality of zones as the amplification medium, the first pump light and the second pump light being among the pump lights supplied from the plurality of pump light sources.

16. An optical transmission system, comprising:
a first optical transmission device configured to transmit an optical signal;
an optical transmission line configured to allow the optical signal to pass therethrough;
a second optical transmission device configured to receive the optical signal through the optical transmission line;
a plurality of pump light sources each configured to supply a pump light that Raman-amplifies the optical signal by employing the optical transmission line as an amplification medium;
a plurality of optical couplers each configured to make the pump light enter the optical transmission line, the plurality of optical couplers forming a plurality of zones in the optical transmission line in cooperation with the first optical transmission device and the second optical transmission device;
a switch configured to enable each of the pump lights supplied from the plurality of pump light source to be output to any one of the plurality of optical couplers; and
a processing portion configured to supply each of the pump lights to any one of the plurality of optical couplers using the switch so as to enable a first pump light in wavelength arrangement at which the first pump light Raman-amplifies a second pump light and the second pump light to Raman amplify the optical signal by employing different zones out of the plurality of zones as the amplification medium, the first pump light and the second pump light being among the pump lights supplied from the plurality of pump light sources.

17. An optical transmission system, comprising:
first and second optical transmission devices configured to transmit first and second optical signals, respectively, in opposite directions;
first and second optical transmission lines configured to allow the first and second optical signals, respectively, to pass therethrough;
the first and second optical devices being configured to receive the second and first optical signals, respectively, in opposite directions through the first and second optical transmission lines,
a plurality of pump light sources configured to supply a plurality of pump lights for Raman-amplifying the first and second optical signals by employing the first and second optical transmission lines as an amplification medium;
third and fourth optical transmission lines configured to allow parts of the plurality of pump lights to bidirectionally pass therethrough, the parts having different wavelengths;
a first optical coupler disposed on the first optical transmission line; and
second, third, and fourth optical couplers disposed on the second optical transmission line,
wherein a direction of the part of the plurality of pump lights bidirectionally propagating through the third optical transmission line is changed by a wavelength demultiplexing filter, the pump light propagating in a first direction is supplied to the first optical coupler, and the pump light propagating in a second direction different from the first direction is supplied to the second optical coupler, and
a direction of the part of the plurality of pump lights bidirectionally propagating through the fourth optical transmission line is changed by a wavelength demultiplexing filter, the pump light propagating in the first direction is supplied to the third optical coupler, and the pump light propagating in the second direction, which is different from the first direction, is supplied to the fourth optical coupler, and
a pump light with a short wavelength is supplied to an optical coupler out of the first to fourth optical couplers that is near to an input end for the optical signal in each of the first and second optical transmission lines, and a pump light with a long wavelength is supplied to an optical coupler out of the first to fourth optical couplers that is near to an output end for the optical signal in each of the first and second optical transmission lines, the pump light with the short wavelength and the pump light with the long wavelength being among the plurality of pump lights.

18. An optical transmission system for communicating between transmission devices, optical transmission system comprising:
a first pump light source that supplies a first pump light;
a second pump light source that supplies a second pump light;
an optical transmission line that propagates an optical signal between the transmission devices; and
a plurality of couplers that form a plurality of zones in the transmission line, the first pump light source and the second pump light source being optically connected to different couplers of the plurality of couplers, the second pump light Raman-amplifying the first pump light in a zone in which the second pump light is input in the transmission line.
